(19) United States
(12) Patent Application Publication
(10) Pub. No.: US 2025/0256625 A1
(43) Pub. Date: Aug. 14, 2025

(54) AN APPARATUS FOR A VEHICLE LOADSPACE OF A VEHICLE

(71) Applicant: Jaguar Land Rover Limited, Whitley, Coventry (GB)

(72) Inventors: Matthew ATKINSON, Warwick, Warwickshire (GB); Emily GREENHALGH, Coventry, Warwickshire (GB); Paul KELLITT, Coventry, Warwickshire (GB); Jessica BUNYAN, Coventry, Warwickshire (GB)

(21) Appl. No.: 18/703,676

(22) PCT Filed: Oct. 14, 2022
(86) PCT No.: PCT/EP2022/078610

§ 371 Date: Apr. 22, 2024

(30) Foreign Application Priority Data
Oct. 22, 2021 (GB) 2115206.1

(51) Int. Cl. B60N 2/30

(52) U.S. Cl. CPC B60N 2/3095; B60N 2/305; B60N 2/3079; B60N 2/3097

(57) ABSTRACT

An apparatus for a vehicle loadspace of a vehicle, comprising: a storage container (603); a panel (108) configured to pivot via a first hinge means (300) between a stowed orientation and a deployed orientation, wherein in the stowed orientation the panel (108) is above the storage container (603), and wherein the panel (108) is configured to pivot through an acute angle to move from the stowed orientation to the deployed orientation; a first cushion member (200), configured to attach to a vehicle loadspace attachment point (350) by a first coupling (401) and movable via the first coupling (401) between a stowed position in the storage container (603) and a deployed position outside the storage container (603), wherein the first coupling (401) is configured to locate the first cushion member (200) when the first cushion member (200) is in the deployed position outside the storage container (603).

### TECHNICAL FIELD

The present disclosure relates to a deployable cushion for use with a vehicle. In particular, but not exclusively it relates to a deployable cushion for use with a vehicle, comprising a deployable cushioned backrest.

### BACKGROUND

In vehicles with a split tailgate, users of the vehicle often open the tailgate and sit on the lower portion of the tailgate. However, the tailgate does not provide the most comfortable of surfaces to sit upon nor does it provide any back support for the user.

### SUMMARY OF THE INVENTION

It is an aim of the present invention to address one or more of the disadvantages associated with the prior art.

Aspects and embodiments of the invention provide an apparatus for a vehicle loadspace, a vehicle etc, as claimed in the appended claims.

According to an aspect of the invention, there is provided a vehicle loadspace of a vehicle. The vehicle loadspace of a vehicle comprises a storage container and a panel configured to pivot via a first hinge means between a stowed orientation and a deployed orientation, wherein in the stowed orientation the panel is above the storage container and is in the plane of a loadspace surface of the vehicle loadspace. The panel is configured to pivot through an acute angle to move from the stowed orientation to the deployed orientation. The vehicle loadspace of the vehicle also comprises a first cushion member, configured to attach to a vehicle loadspace attachment point by a first coupling and movable via the first coupling between a stowed position in the storage container and a deployed position outside the storage container, wherein the first coupling is configured to locate the first cushion member when the first cushion member is in the deployed position outside the storage container.

According to an aspect of the invention, there is provided an apparatus for a vehicle loadspace of a vehicle, comprising: a storage container; a panel configured to pivot via a first hinge means between a stowed orientation and a deployed orientation, wherein in the stowed orientation the panel is above the storage container, and wherein the panel is configured to pivot through an acute angle to move from the stowed orientation to the deployed orientation; a first cushion member, configured to attach to a vehicle loadspace attachment point by a first coupling and movable via the first coupling between a stowed position in the storage container and a deployed position outside the storage container, wherein the first coupling is configured to locate the first cushion member outside the storage container when the first cushion member is in the deployed position.

According to an aspect of the invention, there is provided an apparatus for a vehicle loadspace of a vehicle, comprising: a storage container; a panel configured to pivot via a first hinge means between a stowed orientation and a deployed orientation, wherein in the stowed orientation the panel is above the storage container, and wherein the panel is configured to pivot through an acute angle to move from the stowed orientation to the deployed orientation; a first cushion member, configured to attach to a vehicle loadspace attachment point by a first coupling and movable via the first coupling between a stowed position in the storage container and a deployed position outside the storage container, wherein the first coupling is configured to locate the first cushion member outside the storage container when the first cushion member is in the deployed position.

An advantage is that the vehicle is provided with a deployable seat cushion (first cushion member) and deployable backrest (panel). The first coupling is also multifunctional, in that it both aids deployment of the seat cushion, but also locates the seat cushion once it has been deployed. This is advantageous because this also locates the cushion relative to the deployed panel, controlling the relative positions of the seat and the backrest. This increases user comfort.

Optionally, wherein the vehicle loadspace attachment point is on the storage container.

Optionally, wherein the vehicle loadspace attachment point is a rear lip of the storage container, and the first coupling is fixedly attached to the rear lip of the storage container.

Optionally, wherein the first coupling is a flexible coupling.

Optionally, wherein the first coupling comprises a band of flexible material having one edge portion fixed to the vehicle attachment point and an opposite edge portion fixed to the underside of the cushion member.

Optionally, wherein the opposite edge portion is fixed to a central region of the underside of the cushion member.

Optionally, wherein the first coupling is configured to locate the first cushion member with respect to a lower tailgate of the vehicle when the first cushion member is in the deployed configuration.

The apparatus may comprise a lid for the storage container, wherein the lid may be configured to attach to the vehicle loadspace via a second hinge means, and wherein the panel is on the lid and is attached to the lid by the first hinge means, such that a combination of the lid and the panel is rotatable about the second hinge means to uncover the storage container

An advantage is that easy access is therefore provided to the storage container, easing deployment of the first cushion member. This is because as the panel is on the lid, opening the lid to access the storage container moves the panel out of the way of a user wishing to access the storage container.

The second hinge means and the first hinge means may be located proximal to opposite edges of the lid.

An advantage is that this provides a more space efficient solution, permitting a larger lid for given vehicle loadspace size and thereby improving access to the storage container beneath the lid.

The first coupling may be arranged to enable the first cushion member to move between the stowed position in the storage container and the deployed position, wherein in the deployed position the first cushion member extends away from the lid to define a seat base and remains attached to the storage container by the first coupling.

An advantage is that the first cushion member always remains connected via the first coupling to a fixed point on the vehicle. This prevents the first cushion member from being inadvertently misplaced, once the cushion has been deployed and prior to it being stowed for storage.

The panel may be arranged to pivot via the first hinge means about a first axis relative to the loadspace surface, and the first coupling is arranged to rotate about a second axis, relative to the vehicle loadspace attachment point, wherein the second axis is parallel to the first axis.

An advantage is that when deployed, the relative positions of the first cushion member and panel (acting as a backrest) can be maintained. This enhances user comfort, if for example, the first cushion member and panel extend across substantially the width of the load space.

The panel may have a first edge. The first axis and second axis may be adjacent to the first edge when the panel is in the stowed orientation.

An advantage is that this is a space efficient solution.

Optionally, when in use, in the stowed orientation the panel is in the plane of a loadspace surface of the vehicle loadspace.

The first cushion member may comprise a first portion attached to the vehicle loadspace attachment point by the first coupling and a second portion attached to the first portion by a folding means, wherein in the stowed configuration, the folding means is configured to stow the second portion facing the first portion, and in the deployed configuration, the folding means is configured to deploy the second portion adjacent to the first portion.

An advantage is that this enables space-efficient storage of the first cushion member because, when stowed, the extent of the first cushion member in the x-direction (longitudinal direction of the vehicle) is less than the extent of the first cushion member in the x-direction when deployed.

The folding means and/or the first coupling may comprise a flexible coupling to enable the second portion to rotate with respect to the first portion.

An advantage is that the flexible coupling is unlikely to lock-up during deployment and/or stowage. The flexible coupling is also easy to manufacture, compact and lightweight.

The apparatus may comprise a retaining means for maintaining the panel at a fixed angle to an upper surface of the lid when the panel is in the deployed orientation.

An advantage is that this enables a user to lean against the panel in it deployed orientation, enabling the panel to be used as a backrest.

The first hinge means may be at an aft location of the panel and wherein the vehicle loadspace is a rear loadspace.

An advantage is that the deployable seat, comprising the panel as a seat back, is towards the rear portion of the rear loadspace. This enables a user to easily access the seat when deployed, improving user comfort.

The storage container may be further configured to store a second cushion member, wherein the second cushion member is configured to be removable from the storage container. The second cushion member may comprise coupling means, wherein the coupling means are configured to couple the second cushion member to the panel when the panel is in the first deployed configuration to define a backrest. The second cushion member may have a principal axis that is parallel to the first and second axis.

An advantage is that when the panel is in its deployed orientation, a cushion may now be coupled to the panel. This enhances user comfort as now both the seat and backrest are cushioned.

The coupling means may comprise hooks.

An advantage is that the second cushion member may be easily and quickly attached to and detached from the panel.

According to an aspect of the invention there is provided a vehicle comprising the apparatus for a vehicle loadspace.

According to an aspect of the invention, in the stowed orientation, the panel forms a floor panel within the vehicle loadspace of the vehicle.

An advantage is that the panel is multifunctional, as it may be used to both support items placed within the vehicle loadspace when in a stowed orientation, and as a seat back when in a deployed orientation.

According to an aspect of the invention, there is provided a vehicle having a vehicle load space comprising a loadspace surface, the vehicle comprising:
a storage container positioned below a plane of the vehicle loadspace surface;
a panel configured to pivot via a first hinge means between a stowed orientation and a deployed orientation, wherein in the stowed orientation the panel is above the storage container and is in the plane of the loadspace surface, and wherein the panel is configured to pivot through an acute angle to move from the stowed orientation to the deployed orientation;
   a first cushion member, configured to attach to a vehicle loadspace attachment point by a first coupling and movable via the first coupling between a stowed position in the storage container and a deployed position outside the storage container, wherein the first coupling is configured to locate the first cushion member outside the storage container when the first cushion member is in the deployed position.

The vehicle loadspace attachment point may be on the storage container.

Optionally, the vehicle loadspace attachment point is a rear lip of the storage container, and the first coupling is fixedly attached to the rear lip of the storage container.

Optionally, the first coupling is a flexible coupling.

Optionally, the first coupling comprises a band of flexible material having one edge portion fixed to the vehicle attachment point and an opposite edge portion fixed to the underside of the cushion member. The opposite edge portion may be fixed to a central region of the underside of the cushion member.

The first coupling may be configured to locate the first cushion member with respect to a lower tailgate of the vehicle when the first cushion member is in the deployed configuration.

The vehicle may comprise a lid for the storage container, wherein the lid is configured to attach to the vehicle loadspace via a second hinge means, and wherein the panel is on the lid and is attached to the lid by the first hinge means, such that a combination of the lid and the panel is rotatable about the second hinge means to uncover the storage container.

The second hinge means and the first hinge means may be located proximal to opposite edges of the lid.

Optionally, the first coupling is arranged to enable the first cushion member to move between the stowed position in the storage container and the deployed position, wherein in the deployed position the first cushion member extends away from the lid to define a seat base and remains attached to the storage container by the first coupling.

Optionally, the panel is arranged to pivot via the first hinge means about a first axis relative to the loadspace surface, and the first coupling is arranged to rotate about a second axis, relative to the vehicle loadspace attachment point, wherein the second axis is parallel to the first axis.

The panel may have a first edge, and the first axis and second axis may be adjacent to the first edge when the panel is in the stowed orientation.

Optionally, the first cushion member comprises a first portion attached to the vehicle loadspace attachment point by the first coupling and a second portion attached to the first portion by a folding means, wherein in the stowed configuration, the folding means is configured to stow the second portion facing the first portion, and in the deployed configuration, the folding means is configured to deploy the second portion adjacent to the first portion.

Optionally, the folding means and/or the first coupling comprise a flexible coupling to enable the second portion to rotate with respect to the first portion.

Optionally, the apparatus comprises a retaining means for maintaining the panel at a fixed angle to an upper surface of the lid when the panel is in the deployed orientation.

Optionally, the first hinge means is at an aft location of the panel and the vehicle loadspace is a rear loadspace.

Optionally, the storage container is further configured to store a second cushion member, wherein the second cushion member is configured to be removable from the storage container.

Optionally, the second cushion member comprises coupling means, wherein the coupling means are configured to couple the second cushion member to the panel when the panel is in the first deployed configuration to define a backrest. The coupling means may comprise hooks.

In the stowed orientation the panel may form a floor panel within the vehicle loadspace of the vehicle.

Within the scope of this application, it is expressly intended that the various aspects, embodiments, examples and alternatives set out in the preceding paragraphs, in the claims and/or in the following description and drawings, and in particular the individual features thereof, may be taken independently or in any combination that falls within the scope of the appended claims. That is, all embodiments and/or features of any embodiment can be combined in any way and/or combination that falls within the scope of the appended claims, unless such features are incompatible. The applicant reserves the right to change any originally filed claim or file any new claim accordingly, including the right to amend any originally filed claim to depend from and/or incorporate any feature of any other claim although not originally claimed in that manner

### BRIEF DESCRIPTION OF THE DRAWINGS

One or more embodiments of the invention will now be described, by way of example only, with reference to the accompanying drawings, in which:

FIG. 1 illustrates an example of a vehicle;

FIG. 2 shows a rear perspective view of a vehicle comprising apparatus embodying the present invention in a stowed configuration;

FIG. 3 shows a rear perspective view of the vehicle with the apparatus in a deployed configuration;

FIG. 4 shows a view of the lid and hinge mechanism of the apparatus in the stowed configuration from the side and above;

FIG. 5A shows a first embodiment of the apparatus with its first cushion member, second cushion member and panel in their stowed positions;

FIG. 5B shows a first embodiment of the apparatus with its lid in a raised orientation;

FIG. 5C shows a first embodiment of the apparatus with the first cushion member in its deployed position;

FIG. 5D shows a first embodiment of the apparatus with the first cushion member, second cushion member and panel in their deployed positions;

FIG. 6A shows a second embodiment of the apparatus with its first cushion member, second cushion member and panel in their stowed positions;

FIG. 6B shows a second embodiment of the apparatus with its lid in a raised orientation;

FIG. 6C shows a second embodiment of the apparatus with first cushion member in its deployed position, and

FIG. 6D shows a second embodiment of the apparatus with the first cushion member, second cushion member and panel in their deployed positions.

### DETAILED DESCRIPTION

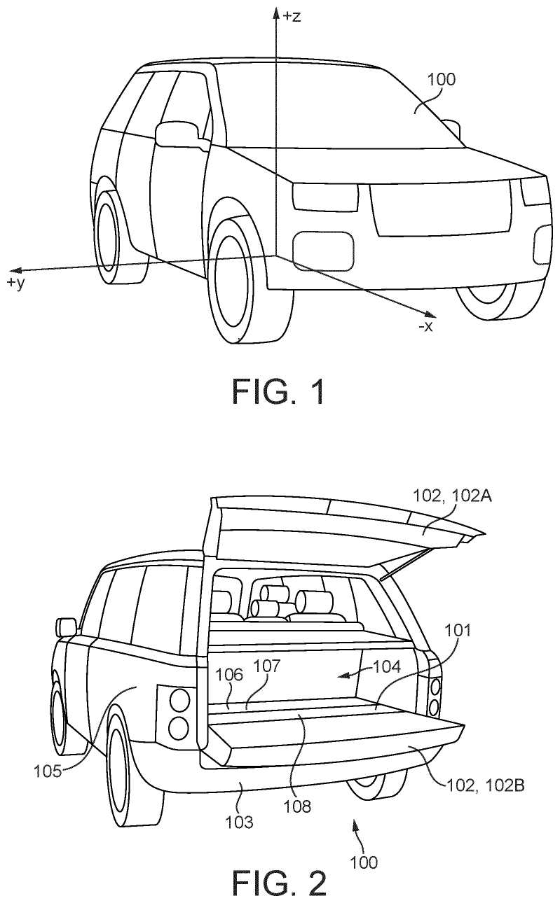

FIG. 1 illustrates an example of a vehicle 100 in which embodiments of the invention can be implemented. In some, but not necessarily all examples, the vehicle is a passenger vehicle, also referred to as a passenger car or as an automobile. In other examples, embodiments of the invention can be implemented for other applications, such as commercial vehicles.

FIG. 1 is a front perspective view and illustrates a longitudinal x-axis between the front and rear of the vehicle 100 representing a centreline, an orthogonal lateral y-axis between left and right lateral sides of the vehicle, and a vertical z-axis. A forward/fore direction typically faced by a driver's seat is in the positive x-direction; rearward/aft is-x. A rightward direction as seen from the driver's seat is in the positive y-direction; leftward is-y. These are a first lateral direction and a second lateral direction.

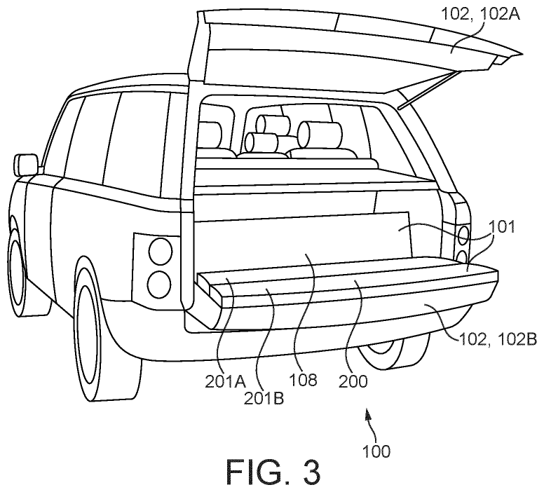

A rear perspective view of a vehicle 100 comprising apparatus 101 embodying the present invention is shown in FIGS. 2 and 3. The vehicle 100 has a tailgate 102 at its rear end 103 to provide access to a load space 104. In the present embodiment the tailgate 102 is a split tailgate having an upper tailgate 102A and a lower tailgate 102B. The upper tailgate 102A is attached to the body 105 of the vehicle 100 by hinges (not shown) at an upper edge of the upper tailgate 102A. The lower tailgate 102B is attached to the body 105 by hinges (not shown) at a lower edge of the lower tailgate 102B so that the lower tailgate 102B is pivotable about a lateral axis between a closed position and an open position. In FIGS. 1 and 2 both the upper tailgate 102A and lower tailgate 102B are shown in their open position. As is known, the lower tailgate 102B may provide a user of the vehicle 100 with a temporary sitting area for use while the vehicle 100 is stationary.

The load space 104 has a floor 106 comprising a load floor board 107. The load floor board 107 may be carpeted on its upper surface.

The apparatus 101 includes a panel 108, which is shown in FIG. 2 in a stowed orientation, in which the panel 108 forms a part of the floor 106 of the loadspace 104. In other words, when the panel 108 is in the stowed configuration, the panel 108 is in the plane of a loadspace surface, such as the floor 106. In the stowed configuration, the panel 108 therefore forms a floor panel in the loadspace 104 of the vehicle. The upper surface of the panel 108 may be carpeted to match the upper surface of the load floor board 107.

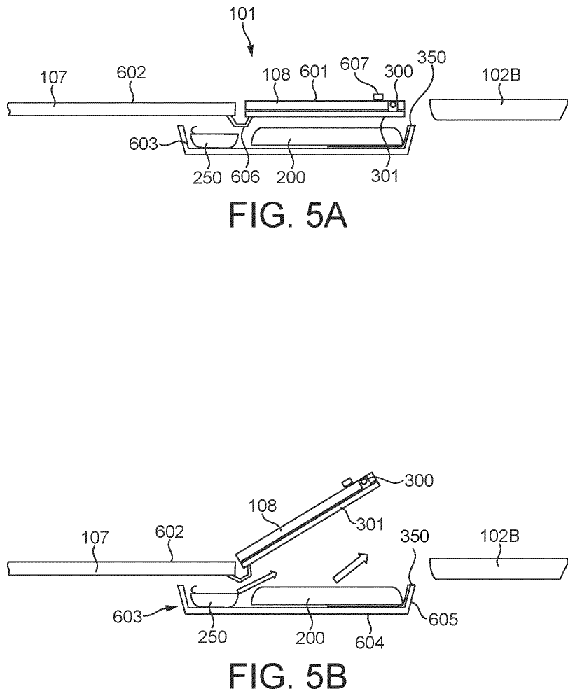

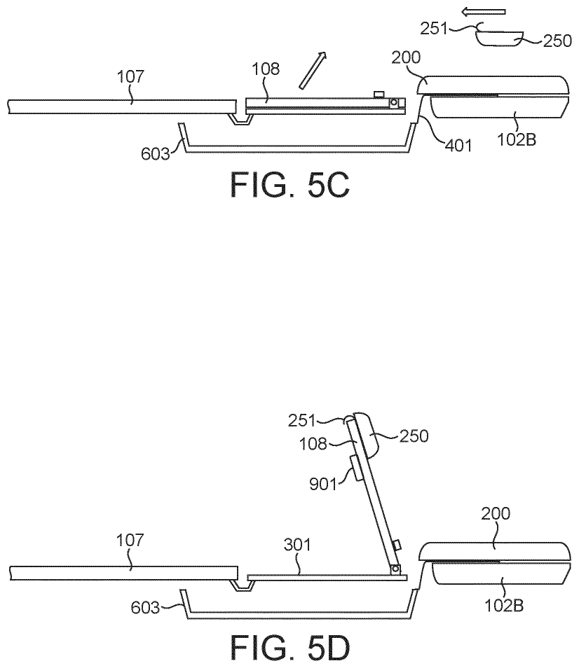

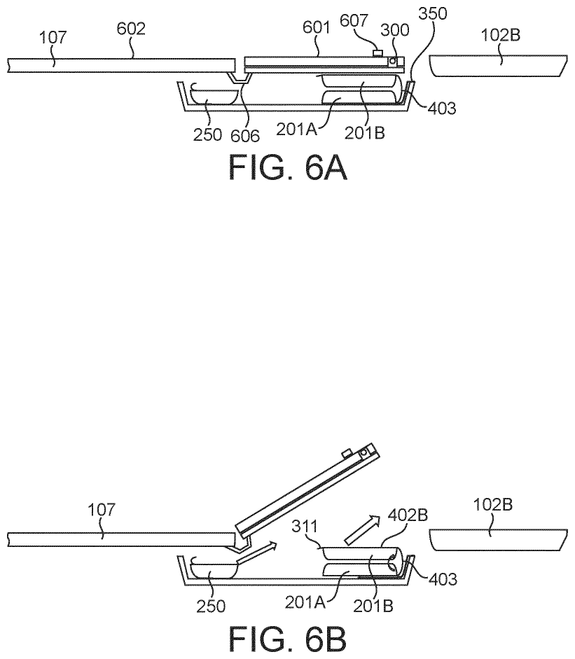

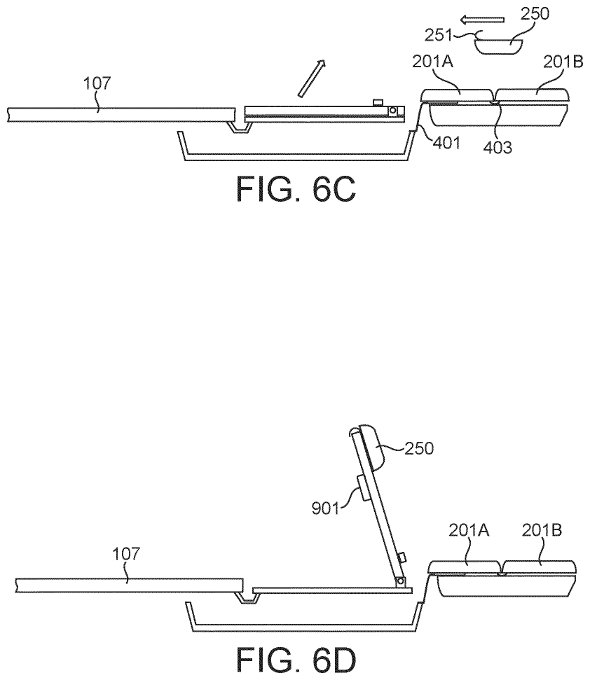

In the stowed position of FIG. 2, the panel 108 resides above a container (603 in FIG. 5A-6D) that contains a first cushion member 200 and a second cushion member 250. The panel 108 may be moved, as will be described below, to enable the first cushion member 200 and second cushion member 250 to be moved out of the container 603 and deployed to form a cushioned seat comprising the opened lower tailgate 102B.

The panel 108 is shown in a deployed orientation in FIG. 3, in which it extends upwards at an acute angle to the horizontal. The acute angle may between 70 degrees and 90 degrees to horizontal, and typically 80 degrees to horizontal. When the first cushion member 200 is in its deployed position, on the lower tailgate as shown in FIG. 2, the panel 108 extends upwards behind the cushion member 200 (as viewed from the rear of the vehicle 100), with the second cushion member 250 attached to the panel to provide a cushioned backrest for a user sitting upon on the first cushion member 200.

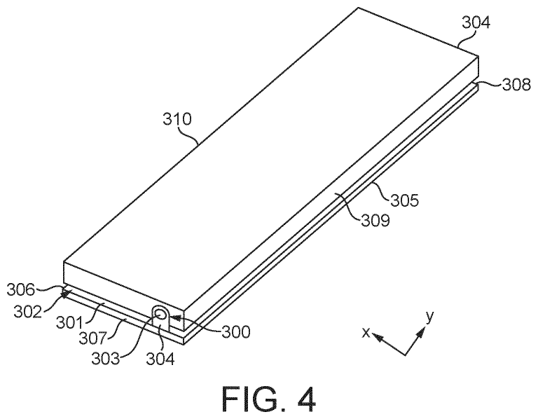

As illustrated by FIG. 4, the panel 108 is substantially rectangular. The panel 108 is pivotally attached to a lid 301 to enable the panel 108 to pivot between the stowed orientation of FIG. 2, in which the panel 108 extends alongside a first face 302 of the lid 301, and a deployed orientation of FIG. 3, in which the panel 108 extends at a positive angle to the first face 302 of the lid 301, The panel 108 is attached to the lid 301 by a first hinge means 300 comprising pivot pins 303 located within brackets 304 that provide bearings for the pivot pins 303. In the present embodiment, the pivot pins 303 are fixed to the panel 108 and the brackets 304, which provide bearings for the pivot pins 303, are fixed to the lid 301. However, in other embodiments, the pivot pins 303 may be fixed to the lid 301 and the panel 108 may comprise bearings in which the pivot pins 303 are arranged to pivot.

In the present embodiment, the brackets 304 and pivot pins 303 are positioned at opposite ends of the panel 108. Additionally, or alternatively, brackets 304 and corresponding pivot pins 303 may be positioned part way along the panel 108.

The lid 301 has a similar shape to the panel 108, and therefore in the present embodiment, the first face 302 of the lid 301 has a rectangular shape, having two longer sides 305 and 306 and two shorter sides 307 and 308. The first long side 305 of the lid 301 extends alongside a first side face 309 of the panel 108 and the second long side 306 extends alongside a second side face 310 of the panel 108.

The panel 108 is attached to the lid 301 by the first hinge means 300 so that it is able to pivot with respect to the lid 301 about an axis 501 that extends next to, and parallel to, the first side face 309 of the panel 108.

The lid 301 is pivotably attached to the loadspace floor board 107 by the second hinge means 606, about a second axis that extends to next to, and parallel to the second side face 310 of the panel 108.

The first hinge means 300 and the second hinge means 606 are therefore located proximal to opposite edges 309, 310 of the lid 301.

The deployment of the first cushion member 200 and the second cushion member 250 is now described with reference to FIGS. 5A-6D, in which FIGS. 5A-5D disclose a first embodiment, and FIGS. 6A-6D disclose a second embodiment.

The first cushion member 200 and second cushion member 250 are formed of relatively soft and pliable materials, and therefore when deployed, provide a user sitting on the lower tailgate 102B with a relatively comfortable area to sit on.

The first cushion member 200 defines a seat base, whereas the second cushion member 250 defines a seat back.

The first cushion member 200 may comprise a single cushion.

Deployment of the first cushion member 200, second cushion member 20 and panel 108 is illustrated in FIGS. 5A, 5B, 5C and 5D, which show cross-sectional side views of the apparatus 101, the load floor board 107, the lower tailgate 102B and a storage container 603.

The storage container 603 may be in the form of an open-top box having a rectangular floor 604 and side walls 605 extending upwards from each side of the floor 604. The storage container 603 is positioned below the floor 106 of the loadspace 104, for example adjacent to a spare wheel (not shown) of the vehicle 100. The container may be formed as an integral portion of the body of the vehicle 100. Alternatively, the container may be separate to the vehicle body, for example, forming part of a module that is attached to the vehicle body during vehicle assembly.

The first cushion member 200, second cushion member 250 and the panel 108 are shown in their stowed positions in FIG. 5A. The upper surface 601 of the panel 108 extends in substantially the same plane as the upper surface 602 of the load floor board 107 to provide a substantially continuous floor 106 for the load space 104. The substantially continuous floor 106 may be a loadspace surface 106.

In its orientation shown in FIG. 5A, the lid 301 extends over the open top of the container 603. The lid 301 is mounted on second hinge means 606 so that it may be pivoted upwards about an axis adjacent to the side 306 of the lid 301 to uncover the storage container 603 and enable access it. The lid 301 is mounted on second hinge means 606 attached to the load floor board 107 of the loadspace 104, but in alternative embodiments the lid 301 may be hingedly attached to another supporting structure in a vehicle 100. The lid 301, or as shown in FIG. 5A, the panel 108, may be provided with a handle 607 to facilitate lifting of the lid 301 away from the storage container 603. The handle 607 may be for example a strap or tab attached to the panel 108.

The lid 301 is shown in a raised orientation in FIG. 5B, for example after being manually lifted by pulling up on the handle 607. It may be noted that the panel 108 continues to reside alongside the upper face 302 of the lid 301. The first cushion member 200 and second cushion member 250 are now accessible and may be removed from the container 603.

The second cushion member 250 is not attached to any other component, and may be removed and placed to one side, for deployment, as will be described.

It may be appreciated that the storage container 603 may be sized such that additional items to the first cushion member 200 and second cushion member 250 may be stored within it. This is advantageous because easy access is provided to the storage container when the lid 301 is in its raised orientation.

The first cushion member is attached by at least one first coupling 401 to a vehicle loadspace attachment point 350. The at least one first coupling 401 may be a flexible coupling. In FIGS. 5A-5D, the vehicle loadspace attachment point 350 is a rear lip of the storage container 603, and the first coupling 401 is fixedly attached to the rear lip of the storage container 603. However, it may alternatively be fixedly connected to another mounting point in the vicinity of the lip of the storage container 603 such as an attachment point on the vehicle body, as would be appreciated by a person skilled in the art.

It may be understood that although described as a vehicle loadspace attachment point 350, the vehicle loadspace attachment point 350 may comprise any one of a point contact, line contact or area contact with the storage container 603 or vehicle body.

In the present embodiment the first coupling 401 comprises a band of flexible material having one edge portion fixed to the vehicle attachment point and an opposite edge portion fixed to the underside of the cushion member 200. For example, the opposite edge portion may be fixed to a central region of the underside of the cushion member 200. The movement of the cushion member 200 with respect to the vehicle loadspace attachment point therefore bends the strip of flexible material forming the first coupling 401, causing the first coupling 401 to rotate about an axis. This axis may be parallel to a line of contact of the first coupling 401 with the vehicle loadspace attachment point 350. In some embodiments, this axis may be in a transverse direction (+/−y direction) relative to the vehicle body. This axis may be parallel to a pivotable axis of the first hinge means and/or second hinge means. When the cushion member 200 is moved with respect to the vehicle loadspace attachment point 350, the cushion member stays in the same orientation, and does not rotate.

Although flexible, the material forming the first coupling 401 is substantially inelastic. Movement of the first cushion member 200 relative to the storage container 603 is therefore substantially constrained by the first coupling.

When the first cushion member 200 is moved from the stowed configuration (FIG. 5B) to the deployed configuration (FIG. 5C), the placement of the first cushion member 200 on the lower tailgate 102B is therefore constrained by the first coupling. In this case, the band of flexible material flexes, to, for example, follow the contour of any underlying surface with which it is in contact. When a user, present at the lower tailgate and facing the loadspace 104, pulls the first cushion member 200 towards them, movement of the first cushion member 200 occurs until the first coupling is pulled taut. No further rearward movement of the cushion member is then possible.

The dimensions of the first coupling 401, location of the vehicle loadspace attachment point 350 and opposing attachment point on the underside of the first cushion member 200 are selected such that when the first coupling 401 is pulled taut, for example, by a user, the first cushion member 200 is over the lower tailgate 102B. The first coupling therefore locates the first cushion member 200 when it is the deployed configuration (deployed on the lower tailgate 102B of the vehicle 100). Similarly, the dimensions of the first coupling 401, location of the vehicle loadspace attachment point 350 and opposing attachment point on the underside of the first cushion member 200 also enable the cushion member 200 to be located in the stowed position in the storage container.

It can be appreciated that the band of flexible material that comprises the first coupling may be substantially equal, or less than substantially equal to the width of the first cushion member 200 (+/−y direction). Hence, pulling the first coupling taut during deployment may additionally control the orientation (relative rotation about the z direction) of the first cushion member 200 relative to the vehicle 100 and/or lower tailgate 102B of the vehicle 100. For example, it can be appreciated that the first coupling may be configured such that an edge of the first cushion member 200 may be substantially parallel (+/−y direction) with an edge of the lower tailgate 102B.

Once the first cushion member 200 has been deployed, and the second cushion member 250 has been removed from the storage container, the lid 301 may be lowered back to its original position, over the storage container 603.

In FIG. 5C, the first cushion member 200 is shown in its deployed position in which the cushion member 200 extends away from the lid 301 in a substantially parallel plane to the second face 400 of the lid 301. The lower tailgate 102B in combination with the cushion member 200 provides a cushioned seat area upon which a user of the vehicle 100 may sit.

The panel 108 may then be moved from its stowed position, in which it extends alongside the first face 302 of the lid 301, to a raised position that is shown in FIG. 5D, in which the panel 108 extends at a positive angle to the first face 302 of the lid 301 and provides a backrest for a user sitting on the cushion member 200. This is achieved by pivoting the panel 108 upwards about the first hinge means 300. A retaining means 901 (illustrated schematically as block 901 in FIG. 5D) is provided for maintaining the panel at the positive angle to the first face. The retaining means 901 may comprise a releasable latching mechanism fixed to side walls of the loadspace 104. Alternatively, the retaining means 901 may form a part of the apparatus 101. For example, the retaining means 901 may comprise struts that extend between the panel 108 and the lid 301 (not shown).

Once panel 108 is in its raised position, the second cushion member 250 may be secured to the panel 108 to form a cushioned back rest. Various coupling means 251 may be used to couple (secure) the second cushion member 250 to the panel 108. For example, at least one hook, 251, may be attached to an upper portion of an undersurface of the second cushion member 250, with the at least one hook 251 configured to hook over the raised edge of the panel 108, as shown in FIG. 5D.

It may be appreciated that a plurality of hooks 251 may be used, for example, a first hook at or a left portion of the second cushion member 251, a second hook, at or close to a right portion of the second cushion member 251 and optionally, a third hook at or close to a center portion of the second cushion member 251.

It may be appreciated that other coupling means 251 may be employed—for example hook and eyelet securing systems such as Velcro™, press-studs, magnetic fasteners or arrangements of doweling & sockets et cetera.

It may also be appreciated that the second cushion member may have substantially the same width (transverse to the vehicle 100) as the first cushion member. However, the second cushion member may not cover the full area of the deployed panel 108. Hence, the second cushion member may be elongate, having a principal axis (in its elongate direction) that is in a transverse direction (+/−y direction) when deployed in the vehicle 100.

Stowage of the first cushion member 200 and second cushion member 250 is the reverse of deployment, in that the second cushion member 250 is removed from the panel, the retaining means 901 disengaged and the panel 108 pivoted back down. The lid 301 is then lifted and the first cushion member 200 and second cushion member 250 returned to their respective stowed positions. The first cushion member 200 may be moved back into container 603, with its movement also optionally constrained by the first coupling 401, so that it is located within a specific portion—for example, a rear portion, of the storage cavity. The second cushion member 250 may then also be placed back into the storage container 603, in the remaining space left after the first cushion member 200 has been stowed.

In the example illustrated in FIGS. 5A and 5B, the second cushion member 250 is returned to a position in the container 603 that is forward of the position of the cushion member 250 in the container. The lid 301 is then closed, completing stowage of the cushion member 200 and second cushion member 250.

It can be appreciated that the length of the storage container (+/−x direction) may be determined by the size of the first cushion member 200 and the second cushion member 250 to be stored.

It can also be appreciated how, for vehicle packaging purposes, it may be desirable to have a differently proportioned storage container, relative to that shown in FIGS. 5A-5D. For example, it may be desirable to have a shorter storage container 603 in the +/−x-direction.

Although this can be accomplished by reducing the size of the first and second cushion members, this is likely to reduce user comfort. This is particularly the case for the first cushion member 200 as it may result in a narrower seat base.

Hence, in an additional embodiment, there is disclosed an alternative first cushion member 200 and a second cushion member 250. The second cushion member 250 is as disclosed above and is stowed and deployed in the same manner.

However, the first cushion member 200 differs in that it comprises two portions 201A and 201B. An underside 402A of the first portion 201A is attached to the vehicle attachment point 350 by the first coupling 401 and a second side 402B of the first portion 201A is attached to the second portion 201B by a folding means 403 arranged to enable the second portion 201B to pivot with respect to the first portion 201A.

Pivoting of the second portion 201B with respect to the first portion 201A is desirable because it enables the seat face of the first portion 201A to be stowed adjacent to the seat face of the second portion 201B in the storage container 603, preventing damage to either seat face. As the first cushion member 200 comprises a first portion 201A and a second portion 201B, stowed on top of each other, the length of the storage compartment (+/−x direction) may be reduced.

Additionally, in the deployed configuration the second portion 201B is deployed adjacent to first portion 201A. Thus, a wider seat base is provided in the deployed configuration on the lower tailgate 102B, enhancing vehicle comfort.

When the lid 301 is raised, the underside 402B of the second portion 201B is visible. A handle 311 may be provided on the underside or at an edge of the second portion 201B to aid deployment of the first portion 201A and second portion 201B of the first cushion member 200 from the stowed position to the deployed position. During deployment, the second portion 201B pivots about the folding means 403 relative to the first portion 201A.

The folding means 403 may comprise a hinge mechanism. In the present embodiment the folding means 403 comprises a live hinge in the form of a strip of flexible material having a first edge attached to the first portion 201A and a second edge attached to the second portion 201B. The strip of flexible material forming the folding means 403 may comprise material forming an outer layer of the cushion portions 201. For example, a continuous sheet of material may form a first face 503 of the first portion 201A and a first face 504 of the second portion 201B, as well as the strip of flexible material that enables the folding of the cushion member 200.

Although flexible, the material of the folding means 403 is substantially inelastic. Hence, the folding means 403 constrains the movement of the second portion 201B relative to the first portion 201A, while the first coupling 401 constrains the movement of the first portion 201A relative to the vehicle loadspace attachment point 350.

The combination of the first coupling 401 and folding means 403 therefore locates the first portion 201A and second portion 201B of the first cushion means 200 when the cushion means is deployed on the lower tailgate 102B.

The first coupling 401 and the folding means 403 therefore function in a similar manner to each other, in that both are flexible, but substantially inelastic.

In some embodiments, the first coupling 401 and folding means 403 comprise the same type of material. Suitable materials include nylon (such as nylon webbing), and leather. In some embodiments, low elasticity automotive grade versions of these materials may be used.

In some embodiments, the first coupling 401 and folding means 403 may comprise the same piece of material, with the underside 401A of first portion 201A and the underside 401B of second portion 201B attached to the material.

Although the above embodiment discloses first and second cushion members which run substantially across the width of the lower tailgate 102B to form a bench seating arrangement, it is appreciated that the first cushion member 200, first portion 201A, second portion 201B, first coupling 401 and folding means 403 may be configured to form separate, adjacent seats on the lower tailgate 102B, each seat extending across less than half the width of the lower tailgate 102B. It is also appreciated that in this case, these seats may be stowed and deployed independently.

It may also be appreciated that although the above embodiments make reference to the deployment of the first cushion member 200 over a lower tailgate 102B, in other embodiments there is no lower tailgate, with the first cushion member 200 alternatively deployed over a rear portion of the loadspace 104 of the vehicle 100.

It will be appreciated that various changes and modifications can be made to the present invention without departing from the scope of the present application. For example, it will be appreciated that the first coupling 401 and folding means 403 could be substituted by a rigid, mechanical arrangement, comprising at least one hinge,

Although embodiments of the present invention have been described in the preceding paragraphs with reference to various examples, it should be appreciated that modifications to the examples given can be made without departing from the scope of the invention as claimed. For example, it will be appreciated that the apparatus may be used to provide a cushioned area with a backrest on the floor of the loadspace of a vehicle that does not have a split tailgate such that a user of the vehicle may comfortably sit, provided the vehicle has space below its floor level to accommodate the apparatus, particularly when the cushion member is in its stowed position.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus for a vehicle loadspace of a vehicle, comprising:
a storage container;
a panel configured to pivot via a first hinge means between a stowed orientation and a deployed orientation, wherein in the stowed orientation the panel is above the storage container, and wherein the panel is configured to pivot through an acute angle to move from the stowed orientation to the deployed orientation;
a first cushion member, configured to attach to a vehicle loadspace attachment point by a first coupling and movable via the first coupling between a stowed position in the storage container and a deployed position outside the storage container, wherein the first coupling is configured to locate the first cushion member outside the storage container when the first cushion member is in the deployed position.

2. An apparatus as claimed in claim 1, wherein the vehicle loadspace attachment point is on the storage container.

3. An apparatus as claimed in claim 2, wherein the vehicle loadspace attachment point is a rear lip of the storage container, and the first coupling is fixedly attached to the rear lip of the storage container.

4. An apparatus as claimed in claim 1, wherein the first coupling is a flexible coupling.

5. An apparatus as claimed in claim 1, wherein the first coupling comprises a band of flexible material having one edge portion fixed to the vehicle attachment point and an opposite edge portion fixed to the underside of the cushion member.

6. An apparatus as claimed in claim 5, wherein the opposite edge portion is fixed to a central region of the underside of the cushion member.

7. An apparatus as claimed in claim 1, wherein the first coupling is configured to locate the first cushion member with respect to a lower tailgate of the vehicle when the first cushion member is in the deployed configuration.

8. The apparatus as claimed in claim 1, wherein the apparatus comprises a lid for the storage container, wherein the lid is configured to attach to the vehicle loadspace via a second hinge means, and wherein the panel is on the lid and is attached to the lid by the first hinge means, such that a combination of the lid and the panel is rotatable about the second hinge means to uncover the storage container.

9. The apparatus as claimed in claim 1, wherein, in use, in the stowed orientation the panel is in the plane of a loadspace surface of the vehicle loadspace.

10. The apparatus as claimed in claim 1, wherein the first cushion member comprises a first portion attached to the vehicle loadspace attachment point by the first coupling and a second portion attached to the first portion by a folding means, wherein in the stowed configuration, the folding means is configured to stow the second portion facing the first portion, and in the deployed configuration, the folding means is configured to deploy the second portion adjacent to the first portion.

11. The apparatus as claimed in claim 1, wherein the apparatus comprises a retaining means for maintaining the panel at a fixed angle to an upper surface of the lid when the panel is in the deployed orientation.

12. The apparatus as claimed in claim 1, wherein the first hinge means is at an aft location of the panel and wherein the vehicle loadspace is a rear loadspace.

13. The apparatus as claimed in claim 1, wherein the storage container is further configured to store a second cushion member, wherein the second cushion member is configured to be removable from the storage container, and optionally wherein the second cushion member comprises coupling means, wherein the coupling means are configured to couple the second cushion member to the panel when the panel is in the first deployed configuration to define a backrest, and optionally wherein the coupling means comprises hooks.

14. A vehicle comprising the apparatus of claim 1.

15. The vehicle of claim 14, wherein in the stowed orientation the panel forms a floor panel within the vehicle loadspace of the vehicle.

16. The apparatus as claimed in claim 8, wherein the second hinge means and the first hinge means are located proximal to opposite edges of the lid.

17. The apparatus as claimed in claim 8, wherein the first coupling is arranged to enable the first cushion member to move between the stowed position in the storage container and the deployed position, wherein in the deployed position the first cushion member extends away from the lid to define a seat base and remains attached to the storage container by the first coupling.

18. The apparatus as claimed in claim 1, wherein the panel is arranged to pivot via the first hinge means about a first axis relative to the loadspace surface, and the first coupling is arranged to rotate about a second axis, relative to the vehicle loadspace attachment point, wherein the second axis is parallel to the first axis.

19. The apparatus as claimed in claim 18, wherein the panel has a first edge, and the first axis and second axis are adjacent to the first edge when the panel is in the stowed orientation.

20. The apparatus as claimed in claim 10, wherein the folding means and/or the first coupling comprise a flexible coupling to enable the second portion to rotate with respect to the first portion.
